(19) United States
(12) Patent Application Publication
(10) Pub. No.: US 2011/0170097 A1
(43) Pub. Date: Jul. 14, 2011

(54) Fiber-Based Optical Probe With Decreased Sample-Positioning Sensitivity

(76) Inventor: Scott A. Chalmers, San Diego, CA (US)

(21) Appl. No.: 13/004,209

(22) Filed: Jan. 11, 2011

Related U.S. Application Data
(60) Provisional application No. 61/295,011, filed on Jan. 14, 2010.
(60) Provisional application No. 61/295,099, filed on Jan. 14, 2010.
(60) Provisional application No. 61/299,887, filed on Jan. 29, 2010.
(60) Provisional application No. 61/313,887, filed on Mar. 15, 2010.

(51) Int. Cl. G01J 3/28; G01B 11/06

(52) U.S. Cl. 356/326; 356/632

(57) ABSTRACT

Reflectance systems and methods are described that under-fill the collection fiber of a host spectrometer both spatially and angularly. The under-filled collection fiber produces a response of fiber-based spectrometers that is relatively insensitive to sample shape and position.

### RELATED APPLICATIONS

This application claims the benefit of U.S. Patent Application No. 61/295,011, filed Jan. 14, 2010.

This application claims the benefit of U.S. Patent Application No. 61/295,099, filed Jan. 14, 2010.

This application claims the benefit of U.S. Patent Application No. 61/299,887, filed Jan. 29, 2010.

This application claims the benefit of U.S. Patent Application No. 61/313,887, filed Mar. 15, 2010.

### TECHNICAL FIELD

This invention relates generally to the field of thin-film metrology.

### BACKGROUND

Many products use film layers to modify surface characteristics. Polycarbonate ophthalmic lenses, for example, use a film hardcoat layer to protect against scratching and chemical attack. The thicknesses of films used in different applications can range from 0.0001 micron (less than an atom thick) to several hundreds of microns. It is usually important to control the thickness of films used and often their composition, whether to optimize the performance of the film or simply to minimize the amount of film precursor that is used.

A common method of measuring the thickness and other properties of non-opaque films less than 500 microns thick is spectral reflectance. Spectral reflectance methods first acquire a range of wavelengths of light reflected off or transmitted through the film structure, which is also known as the “sample” (i.e. the film of interest, along with any other films or substrate present), and then analyze this reflectance (and/or transmittance) spectrum to determine the film's thickness and other properties. See for example “Spectroscopic Ellipsometry and Reflectometry: A User's Guide” by Tompkins and McGahan, John Wiley & Sons, 1999, which also describes spectroscopic ellipsometry, which for our purposes may be considered a type of spectral reflectance. Companies such as Filmetrics, Inc. of San Diego, Calif. manufacture spectral reflectance systems.

Accurate determination of film properties requires acquiring spectra that are an accurate representation of the sample, i.e., the spectra must be significantly free of contributions from the measuring apparatus and its interactions with the shape and relative position of the sample. The light interacting with the sample is generally measured using a spectrometer. The amount of light measured at each wavelength is a product of the light source, the sample, the spectrometer, and the various intermediate optical components used to direct and collect the light.

For the spectra to be significantly unaffected by the shape and relative position of the sample, the light that reflects off the sample and reaches the spectrometer must be relatively independent of any experienced variances in the shape or position of the sample. Because the illumination and collection optics used in nearly all film metrology systems are highly sensitive to sample shape and position, accurate measurements require that such optics be designed for a specific sample shape, and that the sample location and orientation be highly constrained.

Fiber-based spectrometers are common in film metrology systems. Fiber-based spectrometers as thus-called because they use fiber optics to deliver light to the spectrometer input. Fiber-based spectrometers are convenient due to their small size, low cost, robustness, and their ability to be located remotely from the light collection area. Companies such as Filmetrics, Inc. of San Diego, Calif. and Ocean Optics of Dunedin, Fla. manufacture such fiber-based spectrometers. Collecting light into fiber-based spectrometers consists of directing light, sometimes with the assistance of a lens system, onto the face of an assembly that holds the collection fiber. The collection fiber is very small in cross-section (˜200 microns diameter) and is generally much smaller than the light beam intended to be collected. This results in an “over-filled” situation, i.e., a situation where only a fraction of the light intended for the spectrometer makes it into the collection fiber and thus into the spectrometer (here and elsewhere we will be ignoring air-fiber interface reflection effects.)

This over-filled situation makes film metrology systems that are based on fiber-based spectrometers particularly sensitive to sample shape and position. This is because the light collected from the sample and beamed onto the collection fiber end is generally spatially non-uniform, and small perturbations of the sample shape or position cause the portion of the beam that is entering the collection fiber to change.

### INCORPORATION BY REFERENCE

Each publication, patent, and/or patent application mentioned in this specification is herein incorporated by reference in its entirety to the same extent as if each individual publication, patent and/or patent application was specifically and individually indicated to be incorporated by reference.

### BRIEF DESCRIPTION OF THE DRAWINGS

FIG. 1 is a reflectance system 100, under the prior art.

FIG. 2 shows a collection fiber in the under-filled state using the film metrology configuration, under an embodiment.

FIG. 3 is a block diagram of a portion of a film metrology system including the film metrology configuration that results in a spatially and/or angularly under-filled collection fiber, under an embodiment.

FIG. 4 shows an example of sample tilt (shape) immunity of the film metrology configuration, under an embodiment.

FIG. 5 shows an example of sample position immunity of the film metrology configuration, under an embodiment.

FIG. 6 shows example slit configurations used in the film metrology configuration, under an embodiment.

### DETAILED DESCRIPTION

Systems and methods are described herein that include optics configurations that render the response of fiber-based spectrometers relatively insensitive to sample shape and position. The optics configuration can be used as or incorporated in a film metrology system that is insensitive or nearly insensitive to minor changes in sample shape or position. A film metrology system of an embodiment uses the systems and methods described herein to measure films in production environments where the sample shape or position is not reliably defined. Furthermore, a film metrology system of an embodiment makes accurate measurements of film properties, especially of refractive index and thinner films (less than approximately 100 nm), even when there are minor changes in sample shape or position. Moreover, a film metrology system of an embodiment makes accurate measurements of film properties, even when reflections from a backside of a transparent sample are present, by enabling simultaneous measurement of the reflectance of the front side and back side of the sample.

In the following description, numerous specific details are introduced to provide a thorough understanding of, and enabling description for, embodiments of the reflectance systems. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

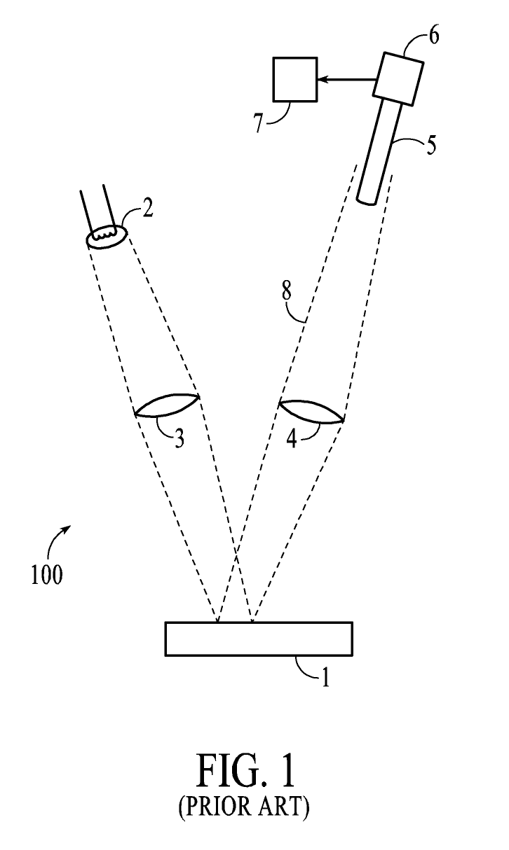

FIG. 1 is a reflectance system 100, under the prior art. The reflectance system 100 is representative of, for example, the Filmetrics F20 system and accessories available from Filmetrics, Inc. of San Diego, Calif., and is configured so that light illuminating the sample 1 and light reflected from the sample 1 take separate paths. The system 100 includes an illumination light source 2, an illumination lens 3, a collection lens 4, a collection fiber 5, a fiber-based spectrometer 6, and a processor running data collection and film analysis software 7. The illumination lens 3 and the collection lens 4 may be refractive lenses or reflective lenses (i.e. mirrors) or combinations of both. An example of a suitable reflective lens is an off-axis parabola. The embodiments described herein also apply to other reflectance and transmittance configurations, such as the beamsplitter-based system described in Tompkins and McGahan.

The collected light 8 impinging on the area of the end of the collection fiber 5 of the reflectance system 100 is in an over-filled state. Thus, an appreciable amount of the light collected by collection lens 4 does not enter collection fiber 5, and is therefore not detected by the spectrometer 6.

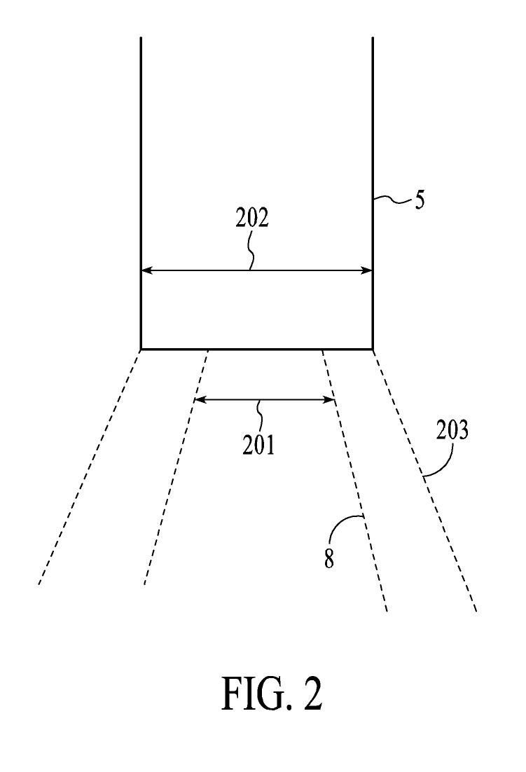

FIG. 2 shows the collection fiber 5 in the under-filled state using the film metrology configuration, under an embodiment. To be under-filled, a fiber must be spatially under-filled (i.e. the impinging light cross-sectional area 201 must fall completely within the area of the face of the end of the fiber 202), and be angularly under-filled. The angularly under-filled requirement comes from the fact that fiber optics only transmit light within a limited acceptance angle 203. The acceptance angle limit of a fiber is generally described by a numerical aperture (NA) value. The NA value is the sine of the cone half-angle. A lower NA means a lower maximum acceptance angle, so to be angularly under-filled, the impinging collected light 8 must have an NA value of less than the NA of the collection fiber 5. Care must be taken to assure that the NA of the collection fiber 5 is less than that of the spectrometer 6, or else that sufficient mode mixing occurs prior to the light entering the spectrometer. Such mode mixing is often accomplished by using a graded-index fiber for the collection fiber 5, or by using a commercially available mode mixer, or by a combination of these or by other methods described in the literature. Examples of mode mixers are available from Avantes, Inc. in Broomfield, Colo. and Newport Corporation in Irvine, Calif. Mode mixing is also generally required if the spectrometer 6 utilizes a slit that apertures the collection fiber 5. As used herein, the term mode mixing refers to the transferring of power from one or more modes of light to one or more other modes of the light as the light is transferred or transmitted from a point of collection to the spectrometer.

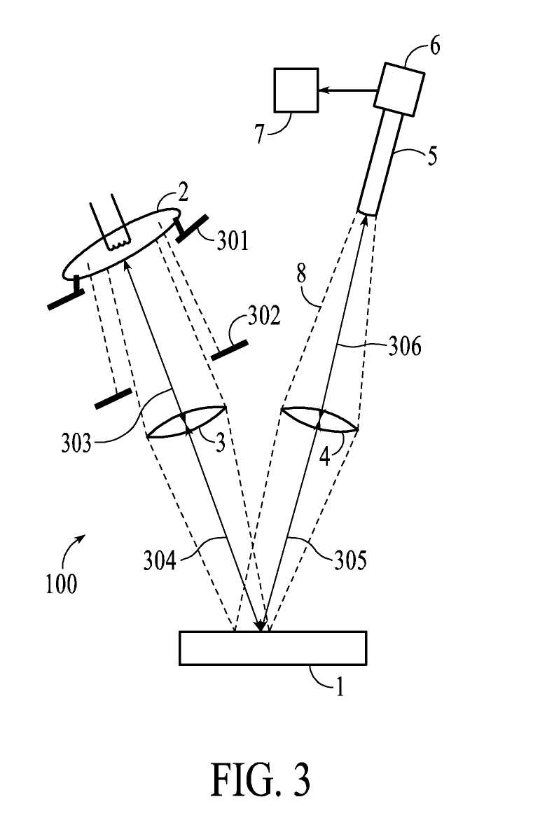

FIG. 3 is a block diagram of a portion of a film metrology system including the film metrology configuration that results in a spatially and/or angularly under-filled collection fiber, under an embodiment. In this embodiment an aperture 301 at the illumination light source 2 determines an effective cross-sectional area (i.e. the effective size of illumination light source 2). An aperture 302 located between the illumination light source 2 and the sample 1 is positioned in such a way so as to affect the NA of the illuminating light beam and thus, ultimately, the NA of the collected light 8. A distance 303 is defined between the illumination light source 2 and the illumination lens 3. Distances 304 and 305 are defined between the sample 1 and the illumination lens 3, and the sample 1 and the collection lens 4, respectively. A distance 306 is defined between the collection lens 4 and the collection fiber 5.

The impinging light cross-sectional area 201 (see FIG. 2) is determined primarily by the illumination light source aperture 301, the four distances 303, 304, 305, and 306, and the focal lengths of the lenses 3 and 4. The effects of the lenses and the distances on the light beam NA and magnification can be calculated to a first order using the thin-lens equation known in the art. If, for simplicity, the focal length of lenses 3 and 4 are set equal to each other, and the distances 303, 304, 305, and 306 are set equal to each other in an embodiment, then the impinging light cross-sectional area 201 is equal to the illumination light source aperture 301. Therefore, in this case, to have a spatially under-filled state for collection fiber 5, the size of the illumination light source aperture 301 is set so that it is smaller than the area of the face of the end of the fiber 202 (i.e. so that its area fits within). In one embodiment, this can be realized using a fiber to transmit light from the illumination light source 2 to the position of the illumination light source aperture 301, and having the diameter of the transmitting fiber serve as the illumination light source aperture 301.

Furthermore, the NA of the impinging collected light 8 is determined primarily by the aperture 302 (unless this NA is greater than the inherent NA of the illumination light source 2), the four distances 303, 304, 305, and 306, and the focal lengths of the lenses 3 and 4. If the focal length of lenses 3 and 4 are set equal to each other and the distances 303, 304, 305, and 306 are set equal to each other, then the NA of the collected light 8 is equal to the NA defined by the aperture 302. Therefore, in this case, to have an angularly under-filled state for collection fiber 5, the size of the aperture 302 is set so that the illumination NA is smaller than the NA of the collection fiber 5. In one embodiment, rather than rely on an aperture 302 to set the illumination NA, a fiber is used to transmit light from the illumination light source 2 to the position of the illumination light source aperture 301, and the illumination NA is set by this transmitting fiber.

Alternatively, different combinations of different lenses 3 and/or 4 and/or different distances 303, 304, 305, and/or 306 can also be used to reduce the NA or the size of the impinging light cross-sectional area 201. However, care must be used in this case, since in general adjusting elements to reduce the impinging light cross-sectional area 201 will simultaneously increase the NA of the collected light 8, and vice versa.

The concepts shown in FIG. 3 are easily extendable to other optical configurations, such as transmittance-measuring systems, ellipsometry systems, and the beamsplitter-based reflectance system described in Tompkins and McGahan.

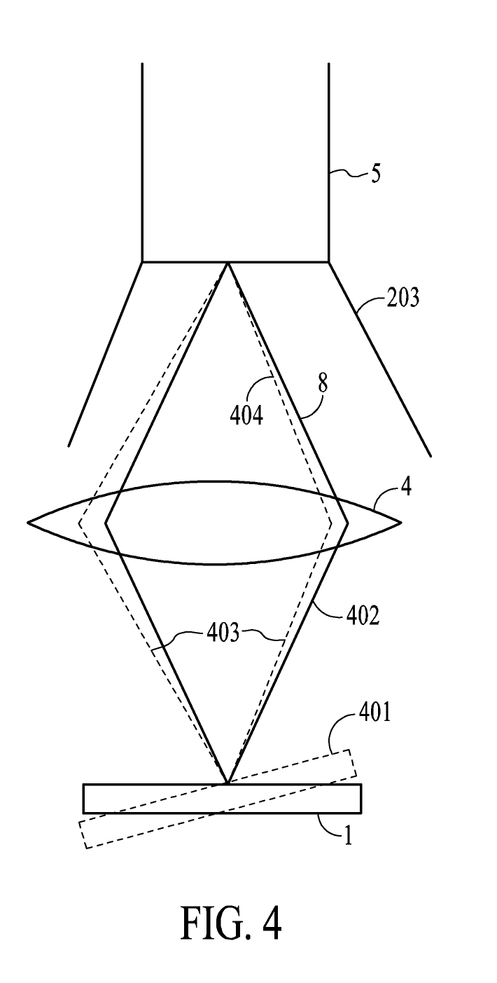

FIG. 4 shows an example of sample tilt (shape) immunity of the film metrology configuration, under an embodiment. For clarity, only the optical portion of the collection side of the system is shown. Also for clarity, sample 1 is shown nominally oriented normal to the collection lens 4, and the collection lens 4 is shown focusing the sample 1 image onto the collection fiber 5 (often desirable, but not necessary, in practice).

In the absence of sample tilt, a cone 402 of the collected light beam results. Tilting of the sample 1 to a tilted position 401 produces a collected light beam comprising bottom cone 403 and top cone 404, respectively. Since the sample is not changing in height, the location that lens 4 focuses the collected light 404 onto the collection fiber 5 will be unchanged. More important is that the tilted cone of collected light 402 remains within the circumference of lens 4 and that the angle of the upper cone 404 remains less than or equal to the angle of 203 (FIG. 2) (i.e., the NA of 404 remains less than or equal to the NA of the collection fiber 5.) Thus, even with the sample tilted, all of the light reflected from sample 1 is collected by collection fiber 5, and sent to the spectrometer 6 for detection under an embodiment. Therefore accurate measurement of reflectance and/or the film properties of sample 1 are possible.

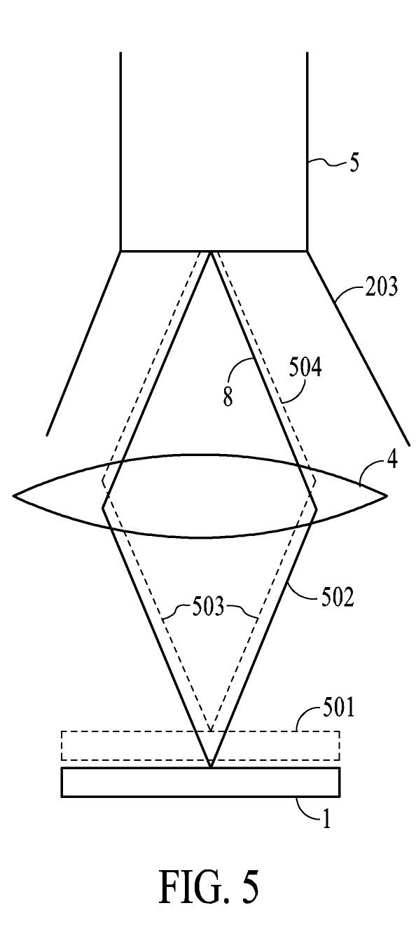

FIG. 5 shows an example of sample position immunity of the film metrology configuration, under an embodiment. For clarity, only the optical portion of the collection side of the system is shown. Also for clarity, sample 1 is shown nominally oriented normal to the collection lens 4, and the collection lens 4 is shown focusing the sample 1 image onto the collection fiber 5 (often desirable, but not necessary, in practice).

In the absence of sample displacement, a cone 502 of the collected light beam results. Displacement of the sample 1 to an elevated position 501 produces a collected light beam comprising bottom cone 503 and top cone 504, respectively. Note that even when the sample height is changed, all of the light reflected from sample 1 is collected by collection fiber 5, and sent to the spectrometer 6 for detection under an embodiment. Therefore accurate measurement of reflectance and/or the film properties of sample 1 are possible.

As described above, mode mixing is generally used if the spectrometer 6 includes or couples to an aperture that apertures the collection fiber 5. The aperture of an embodiment is a slit, but is not so limited. Light impinging on collection fiber 5 with different spatial and/or angular characteristics excites different fiber modes, and the slit tends to pass the different modes preferentially. Therefore, changes in sample height or tilt result in different amounts of light being passed into and detected by spectrometer 6. If the modes are perfectly mixed before they reach the slit, then the mode distribution at the slit is effectively the same no matter what the sample height or tilt is, and the slit therefore does not change the fraction of light it passes as a function of sample height or tilt.

An alternative to effectively-perfect mode mixing is for spectrometer 6 to be used without a slit. However, this is generally not practical because a slit is used for reasonable spectrometer wavelength resolution. An alternative to using the spectrometer 6 with a slit is for the slit to be configured to pass the different modes as proportionally as possible.

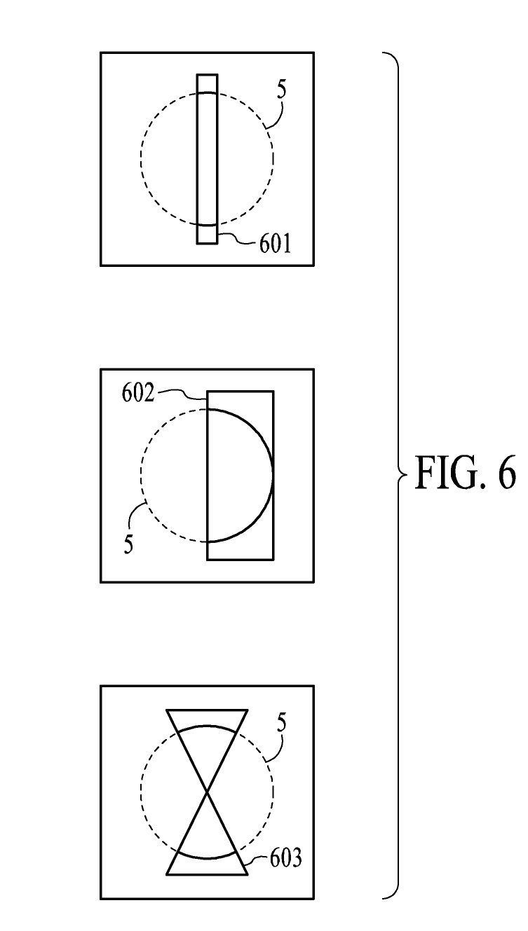

FIG. 6 shows example slit configurations used in the film metrology configuration, under an embodiment. The slits of an embodiment include a conventional or straight slit aperture 601 used in spectrometers and shown relative to a position of the collection fiber 5. The straight slit 601 preferentially passes a greater fraction of the light that is at the center of the fiber 5 than it does light that is at the outer circumferences of the fiber, and therefore does not pass all modes of light proportionally.

The slits of an embodiment include a slit 602 configured to pass equal proportions of light from all fiber circumferences. This slit 602 blocks effectively one-half of the fiber face. This slit 602 passes lobed and spherically-symmetric fiber modes proportionally, but it only reduces the slit aperture width to be half of the fiber width.

The slits of an embodiment include a bow tie-shaped slit 603. The bow tie slit 603 reduces the slit width and thus retains much or all of the spectrometer resolution of the conventional slit 601 and passes spherically-symmetric modes proportionally. This bow tie slit 603 also passes equal proportions of light from all fiber circumferences, as required. The slit 602 and bow tie slit 603 can be used for thin-film measurement, but they can also be used to provide similar immunity to fiber-filling changes encountered in fiber-based spectrometers in general.

Embodiments described herein include a film metrology system comprising a light source outputting light that illuminates a sample. The system of an embodiment includes a collection fiber that collects light from the sample. The system of an embodiment includes a first aperture that controls the light so that a cross-sectional area of the light spatially under-fills the collection fiber. The system of an embodiment includes a second aperture that controls the light so that a numerical aperture of the light angularly under-fills the collection fiber.

Embodiments described herein include a film metrology system, comprising: a light source outputting light that illuminates a sample; a collection fiber that collects light from the sample; a first aperture that controls the light so that a cross-sectional area of the light spatially under-fills the collection fiber; and a second aperture that controls the light so that a numerical aperture of the light angularly under-fills the collection fiber.

The first aperture of an embodiment is positioned between the light source and the sample.

The second aperture of an embodiment is positioned between the first aperture and the sample.

The system of an embodiment includes a first lens positioned to direct the light of the light source to the sample.

The first aperture of an embodiment is positioned between the light source and the first lens.

The second aperture of an embodiment is positioned between the first aperture and the first lens.

The system of an embodiment includes a second lens positioned to direct the light from the sample to the collection fiber.

The first aperture of an embodiment reduces the cross-sectional area of the light source.

The second aperture of an embodiment reduces the numerical aperture of the light source.

The first aperture of an embodiment controls the light so that the cross-sectional area of the light falls completely within an area of a collection end the collection fiber.

A diameter of the first aperture of an embodiment is smaller than the area of the collection end the collection fiber.

The second aperture of an embodiment controls the light so that the numerical aperture of the light is smaller than the numerical aperture of the collection fiber. The system of an embodiment includes a spectrometer coupled to the collection fiber.

The numerical aperture of the collection fiber of an embodiment is less than the numerical aperture of the spectrometer.

The collection fiber of an embodiment is a graded-index fiber that transfers power among modes of the light input into the spectrometer.

The system of an embodiment includes a mode mixer coupled to the collection fiber and the spectrometer, wherein the mode mixer transfers power among modes of the light input into the spectrometer.

The system of an embodiment includes a third aperture that apertures light output of the collection fiber.

The third aperture of an embodiment is a straight slit-shaped aperture. The third aperture of an embodiment blocks approximately one-half of a face of the collection fiber.

The third aperture of an embodiment is a bow tie-shaped aperture.

Embodiments described herein include a film metrology system comprising a lens that directs light from a light source to a sample. The system of an embodiment includes a collection fiber that collects light from the sample. The system of an embodiment includes a first aperture located between the light source and the sample. The first aperture controls a cross-sectional area of the light so that the light spatially under-fills the collection fiber. The system of an embodiment includes a second aperture located between the light source and the sample. The second aperture controls a numerical aperture of the light so that the light angularly under-fills the collection fiber.

Embodiments described herein include a film metrology system, comprising: a lens that directs light from a light source to a sample; a collection fiber that collects light from the sample; a first aperture located between the light source and the sample, wherein the first aperture controls a cross-sectional area of the light so that the light spatially under-fills the collection fiber; and a second aperture located between the light source and the sample, wherein the second aperture controls a numerical aperture of the light so that the light angularly under-fills the collection fiber.

Embodiments described herein include a film metrology method comprising directing light from a light source to illuminate a sample. The method of an embodiment comprises collecting via a collection fiber light from the sample. The method of an embodiment comprises controlling a cross-sectional area of the light so that the light spatially under-fills the collection fiber. The method of an embodiment comprises controlling a numerical aperture of the light so that the light angularly under-fills the collection fiber.

Embodiments described herein include a film metrology method, comprising: directing light from a light source to illuminate a sample; collecting via a collection fiber light from the sample; controlling a cross-sectional area of the light so that the light spatially under-fills the collection fiber; and controlling a numerical aperture of the light so that the light angularly under-fills the collection fiber.

The controlling of the cross-sectional area of the light of an embodiment comprises positioning a first aperture between the light source and the sample.

The controlling of the numerical aperture of the light of an embodiment comprises positioning a second aperture between the first aperture and the sample.

The method of an embodiment comprises positioning a first lens to direct the light of the light source to the sample.

The method of an embodiment comprises positioning the first aperture between the light source and the first lens.

The method of an embodiment comprises positioning the second aperture between the first aperture and the first lens.

The method of an embodiment comprises reducing via a first aperture the cross-sectional area of the light source.

The method of an embodiment comprises reducing via a second aperture the numerical aperture of the light source.

The method of an embodiment comprises controlling the light via a first aperture so that the cross-sectional area of the light falls completely within an area of a collection end the collection fiber.

A diameter of the first aperture of an embodiment is smaller than the area of the collection end the collection fiber.

The method of an embodiment comprises controlling the light via a second aperture so that the numerical aperture of the light is smaller than the numerical aperture of the collection fiber.

The method of an embodiment comprises inputting the light into a spectrometer coupled to the collection fiber.

The numerical aperture of the collection fiber of an embodiment is less than the numerical aperture of the spectrometer.

The collection fiber of an embodiment is a graded-index fiber that transfers power among modes of the light input into the spectrometer.

The method of an embodiment comprises transferring power among modes of the light input into the spectrometer via a mode mixer coupled to the collection fiber and the spectrometer.

The method of an embodiment comprises controlling light output of the collection fiber using a third aperture.

The third aperture of an embodiment is a straight slit-shaped aperture.

The third aperture of an embodiment blocks approximately one-half of a face of the collection fiber.

The third aperture of an embodiment is a bow tie-shaped aperture.

The embodiments described herein include a fiber-based reflectance and/or transmittance measuring method that collects most or all of the sampling light striking the sample-under-test by spatially and angularly under-filling the light-collection fiber.

The embodiments described herein include an illumination source that is apertured to reduce the cross-sectional area of the light beam source.

The embodiments described herein include an illumination source aperture defined by the diameter of an optical fiber.

The embodiments described herein include an illumination source that is apertured to reduce its numerical aperture.

The embodiments described herein include collection optics that reduce the light beam diameter to less than the collection fiber diameter.

The embodiments described herein include collection optics that reduce the light beam numerical aperture to less than the collection fiber numerical aperture.

The embodiments described herein include slits that pass all fiber modes, including lobed modes or spherical modes or both.

The embodiments described herein include a fiber-based reflectance and/or transmittance measuring system.

The embodiments described herein include a fiber-based film measuring method.

The embodiments described herein include a fiber-based film measuring system.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the reflectance systems and methods is not intended to be exhaustive or to limit the systems and methods described to the precise form disclosed. While specific embodiments of, and examples for, the reflectance systems and methods are described herein for illustrative purposes, various equivalent modifications are possible within the scope of other reflectance systems and methods, as those skilled in the relevant art will recognize. The teachings of the reflectance systems and methods provided herein can be applied to other processing and measurement systems and methods, not only for the systems and methods described above.

The elements and acts of the various embodiments described above can be combined to provide further embodiments. These and other changes can be made to the reflectance systems and methods in light of the above detailed description.

In general, in the following claims, the terms used should not be construed to limit the reflectance systems and methods to the specific embodiments disclosed in the specification and the claims, but should be construed to include all systems and methods that operate under the claims. Accordingly, the reflectance systems and methods are not limited by the disclosure, but instead the scope of the reflectance systems and methods is to be determined entirely by the claims.

While certain aspects of the reflectance systems and methods are presented below in certain claim forms, the inventors contemplate the various aspects of the reflectance systems and methods in any number of claim forms. Accordingly, the inventors reserve the right to add additional claims after filing the application to pursue such additional claim forms for other aspects of the reflectance systems and methods.

What is claimed is:

1. A film metrology system, comprising:
a light source outputting light that illuminates a sample;
a collection fiber that collects light from the sample;
a first aperture that controls the light so that a cross-sectional area of the light spatially under-fills the collection fiber; and
a second aperture that controls the light so that a numerical aperture of the light angularly under-fills the collection fiber.

2. The system of claim 1, wherein the first aperture is positioned between the light source and the sample.

3. The system of claim 2, wherein the second aperture is positioned between the first aperture and the sample.

4. The system of claim 1, comprising a first lens positioned to direct the light of the light source to the sample.

5. The system of claim 4, wherein the first aperture is positioned between the light source and the first lens.

6. The system of claim 5, wherein the second aperture is positioned between the first aperture and the first lens.

7. The system of claim 4, comprising a second lens positioned to direct the light from the sample to the collection fiber.

8. The system of claim 1, wherein the first aperture reduces the cross-sectional area of the light source.

9. The system of claim 1, wherein the second aperture reduces the numerical aperture of the light source.

10. The system of claim 1, wherein the first aperture controls the light so that the cross-sectional area of the light falls completely within an area of a collection end the collection fiber.

11. The system of claim 10, wherein a diameter of the first aperture is smaller than the area of the collection end the collection fiber.

12. The system of claim 1, wherein the second aperture controls the light so that the numerical aperture of the light is smaller than the numerical aperture of the collection fiber.

13. The system of claim 12, comprising a spectrometer coupled to the collection fiber.

14. The system of claim 13, wherein the numerical aperture of the collection fiber is less than the numerical aperture of the spectrometer.

15. The system of claim 13, wherein the collection fiber is a graded-index fiber that transfers power among modes of the light input into the spectrometer.

16. The system of claim 13, comprising a mode mixer coupled to the collection fiber and the spectrometer, wherein the mode mixer transfers power among modes of the light input into the spectrometer.

17. The system of claim 13, comprising a third aperture that apertures light output of the collection fiber.

18. The system of claim 17, wherein the third aperture is a straight slit-shaped aperture.

19. The system of claim 17, wherein the third aperture blocks approximately one-half of a face of the collection fiber.

20. The system of claim 17, wherein the third aperture is a bow tie-shaped aperture.

21. A film metrology system, comprising:
a lens that directs light from a light source to a sample;
a collection fiber that collects light from the sample;
a first aperture located between the light source and the sample, wherein the first aperture controls a cross-sectional area of the light so that the light spatially under-fills the collection fiber; and
a second aperture located between the light source and the sample, wherein the second aperture controls a numerical aperture of the light so that the light angularly under-fills the collection fiber.

22. A film metrology method, comprising:
directing light from a light source to illuminate a sample;
collecting via a collection fiber light from the sample;
controlling a cross-sectional area of the light so that the light spatially under-fills the collection fiber; and
controlling a numerical aperture of the light so that the light angularly under-fills the collection fiber.

23. The method of claim 22, wherein the controlling of the cross-sectional area of the light comprises positioning a first aperture between the light source and the sample.

24. The method of claim 23, wherein the controlling of the numerical aperture of the light comprises positioning a second aperture between the first aperture and the sample.

25. The method of claim 22, comprising positioning a first lens to direct the light of the light source to the sample.

26. The method of claim 25, comprising positioning the first aperture between the light source and the first lens.

27. The method of claim 26, comprising positioning the second aperture between the first aperture and the first lens.

28. The method of claim 22, comprising reducing via a first aperture the cross-sectional area of the light source.

29. The method of claim 22, comprising reducing via a second aperture the numerical aperture of the light source.

30. The method of claim 22, comprising controlling the light via a first aperture so that the cross-sectional area of the light falls completely within an area of a collection end the collection fiber.

31. The method of claim 30, wherein a diameter of the first aperture is smaller than the area of the collection end the collection fiber.

32. The method of claim 22, comprising controlling the light via a second aperture so that the numerical aperture of the light is smaller than the numerical aperture of the collection fiber.

33. The method of claim 32, comprising inputting the light into a spectrometer coupled to the collection fiber.

34. The method of claim 33, wherein the numerical aperture of the collection fiber is less than the numerical aperture of the spectrometer.

35. The method of claim 33, wherein the collection fiber is a graded-index fiber that transfers power among modes of the light input into the spectrometer.

36. The method of claim 33, comprising transferring power among modes of the light input into the spectrometer via a mode mixer coupled to the collection fiber and the spectrometer.

37. The method of claim 33, comprising controlling light output of the collection fiber using a third aperture.

38. The method of claim 37, wherein the third aperture is a straight slit-shaped aperture.

39. The method of claim 37, wherein the third aperture blocks approximately one-half of a face of the collection fiber.

40. The method of claim 37, wherein the third aperture is a bow tie-shaped aperture.
